(19) United States
(12) Patent Application Publication
(10) Pub. No.: US 2001/0046141 A1
(43) Pub. Date: Nov. 29, 2001

(54) Light arrangement comprising several leds

(75) Inventors: Steffen Walker, Filderstadt (DE); Bernd Merz, Frickenhausen (DE)

Correspondence Address: POLSTER, LIEDER, WOODRUFF & LUCCHESI, 763 SOUTH NEW BALLAS ROAD, ST. LOUIS, MO, 63141-8750, US

(73) Assignee: Sidler GmbH & Co.

(21) Appl. No.: 09/855,644

(22) Filed: May 4, 2001

(30) Foreign Application Priority Data
May 9, 2000 (EP) 00 109 779.9

(51) Int. Cl. F21V 21/00

(52) U.S. Cl. 362/555; 362/249; 362/800

(57) ABSTRACT

A light arrangement (1) comprising at least two spaced apart contact plates (3,5) and comprising several LEDs connected to the contact plates (3,5) in an electrically conducting fashion. The contact plates (3,5) are spaced apart from one another by an electrically insulating carrier (6) thereby achieving an optimum heat conduction from the LEDs. The LEDs are electrically mounted to projections extending from one of the contact plates towards the other contact plate. The carrier (6) is preferably a plastic layer covering at least part of the contact plates (3,5).

### BACKGROUND OF THE INVENTION

The invention concerns a light arrangement comprising at least two contact plates spaced apart from one another, and several LEDs connected to the contact plates in an electrically conducting fashion.

In a known light arrangement, light-emitting diodes (LEDs) are pressed on a punch grid thereby keeping the individual contact plates of the punch grid spaced apart from one another. FIG. 5a shows such a known light arrangement 50 comprising two LEDs 51 (so-called HP SNAP LED) whose broad contacts 52 (FIG. 5b) are clinched (pressed) onto each of the contact plates 53, 54. The SNAP LED technology, however, has the disadvantage that these LEDs are very expensive and must be purchased in large amounts.

Printed boards comprising soldered-on LEDs (wired or SMD) are known, in particular, for signal lights. Such printed boards with LEDs assembled are very expensive due to the relatively expensive LEDs and the soldering process.

Finally also light arrangements are known, wherein several LED chips are mounted directly on a printed board (plate). This method is known as “Chip on Board (COB)”. Such light arrangements are mainly used as back light for symbols or switches and large-scale displays. Due to the broad angle of radiation, these LEDs are not used for signal lights. FIGS. 6a and 6b show a known light arrangement 60 comprising a COB-LED chip 61 which is mounted on a printed board 62. The LED chip 61 is mounted with a lower contact surface in an electrically conducting fashion by means of silver conducting adhesive 63 onto a thin gold contact surface (anode) 64 of the printed board 62. The upper side of the LED chip 61 comprises an upper contact surface which is connected to another gold contact surface (cathode) 66 of the printed board 62 in an electrically conducting fashion by means of a bonded gold wire 65. The two gold contact surfaces 64, 66 are electrically insulated from one another. The LED chip 61 and the two contact surfaces 64, 66 are covered by a protective layer 67. However, due to the very thin deposit of copper on the conductor plate 62, heat conduction from the LED chip 61 to the surroundings is very low. Therefore, the LED current must be reduced which requires a larger number of LEDs or more expensive LEDs.

It is therefore the object of the invention, to improve a light arrangement of the initially mentioned type in such a fashion, that a heat dissipation from the LEDs, which is as high as possible, can be achieved with low production costs.

### SUMMARY OF THE INVENTION

This object is achieved in the initially mentioned light arrangement in that the contact plates are spaced apart from one another via an electrically insulating carrier.

The advantage obtained by the invention consists in that heat conduction from the LEDs into the surroundings is considerably improved by the large thickness or cross-section of the contact plates (approximately 0.2 to approximately 1 mm) compared to the copper coating of a conventional printed board. This permits a considerable increase of the maximum admissible LED current and reduction of the required number of LEDs which saves costs. On the other hand, the failure safety at high temperatures can be improved with low current. The small number of structural components and omission of the soldering process and mounting bores permits smaller tolerances for mounting the LED and thus a more uniform appearance. Omission of the printed board production (illumination, etching, lacquering with solder stop lacquer) reduces the environmental burden. This method also permits stepped shoulders in the contact plates. The light arrangement can then be inserted e.g. in rear lights of a vehicle wherein the stepped shoulders facilitate adaptation of the position of the LEDs to the outer contour of the rear light.

The preferably stripe-shaped contact plates may be commonly punched, cut or etched out of a sheet metal. As an alternative it is also possible to use two individual contact plates which are fixed at a separation with respect to one another through the electrically insulating carrier.

The carrier may be provided on the upper and/or lower side of the contact plates. The two contact plates can be glued to the common carrier or be mounted in any other fashion.

In a particularly preferred fashion, the carrier is produced through plastic coating of the contact plates by injection molding. This measure has the advantage that the plastic coating provides protection of the entire light arrangement during transport and assembly. It is possible at the same time to injection mold means which facilitate fixing of the light arrangement in a housing. The carrier may be designed directly as housing of the light arrangement or as housing for connection contacts of the contact plates. These connection contacts of the light arrangement (e.g. contact receivers) are preferably integrated in the contact plates, e.g. punched out, and then also injection-coated. Such a plastic coating can thus simultaneously form a plug housing for the contact receivers thereby omitting the costs for such additional parts. This reduces the number of structural components and also the assembly tolerances since there are no tolerances between contact plates and housing, i.e. the quality is improved and costs are reduced.

Each LED may at least partly be covered by the carrier, in particular injection-coated, such that the LEDs are protected by the plastic coating. However, the cover must be transparent to the light from the LED.

Each LED may be mounted to the one contact plate in an electrically conducting fashion and be connected to the other contact plate through a bonded wire in an electrically conducting fashion. This electric connection is particularly suited for COB structural components (e.g. for an LED chip) which are mounted with their lower contact surface to the one contact plate in an electrically conducting fashion. The upper side of the COB structural component comprises an upper contact surface which is connected to the other contact plate by means of a wire in an electrically conducting fashion. Through the COB technique there are no costs for production and assembly of the other LED components (lead frame, housing, . . . ) which considerably reduces the costs for one LED. It is therefore possible to compensate for the light loss caused by the broad light radiation of the COB LED chip through further COB LED chips. The entire light arrangement is nevertheless considerably cheaper than a conventional light arrangement with SNAP LEDs or with soldered LEDs. The distance between LEDs can furthermore be reduced which produces a more homogeneous appearance of the light arrangement.

Since LED chips have a very broad angle of radiation (up to 180°), the use of Fresnel optics is only somewhat effective. The largest amount of the emitted light reaches the housing and is not detected by the optics. As an alternative, reflector optics would be feasible, but an arrangement of the LED in the focus of the reflector is very difficult due to the small constructional height and the reflector is not very effective. Vaporisation of the reflector surface is required which causes high costs. It is therefore particularly advantageous if the carrier forms one reflector section for the respective LED around each carrier-free seat region. The reflector section may be a polished (e.g. white) funnel which reflects the light radiated laterally by the LED towards the front. This may further increase the optical efficiency of the LED and the number of LEDs required in the light arrangement is reduced. The radiation characteristics of the LED can thus be influenced and adapted to the requirements. The plastic coating of the contact plates and the LEDs inserted into the reflector section render the entire light arrangement more insensitive to damages.

Protection of the light arrangement is improved if the LEDs are covered in the carrier-free seat region by a separate protective layer each. This protective layer may be e.g. a resin layer or silicone layer which are transparent for the light of the LED.

Further advantages of the invention can be gathered from the description and the drawings. The features mentioned above and below may be used in accordance with the invention either individually or collectively in any arbitrary combination. The embodiments shown and described are not to be understood as exhaustive enumeration but rather have exemplary character for describing the invention.

### BRIEF DESCRIPTION OF THE DRAWING

FIG. 1 shows schematically an embodiment of an inventive light arrangement;

FIG. 2a shows the first step of a first method for producing the light arrangement shown in FIG. 1;

FIG. 2b shows the second step of a first method for producing the light arrangement shown in FIG. 1;

FIG. 2c shows the third step of a first method for producing the light arrangement shown in FIG. 1;

FIG. 2d shows the fourth step of a first method for producing the light arrangement shown in FIG. 1;

FIG. 2e shows the fifth step of a first method for producing the light arrangement shown in FIG. 1;

FIG. 3a shows the first step of a second method for producing the light arrangement shown in FIG. 1;

FIG. 3b shows the second step of a second method for producing the light arrangement shown in FIG. 1;

FIG. 3c shows the third step of a second method for producing the light arrangement shown in FIG. 1;

FIG. 3d shows the fourth step of a second method for producing the light arrangement shown in FIG. 1;

FIG. 3e shows the fifth step of a second method for producing the light arrangement shown in FIG. 1;

FIG. 4a shows the first step of a third method for producing the light arrangement shown in FIG. 1;

FIG. 4b shows the second step of a third method for producing the light arrangement shown in FIG. 1;

FIG. 4c shows the third step of a third method for producing the light arrangement shown in FIG. 1;

FIG. 4d shows the fourth step of a third method for producing the light arrangement shown in FIG. 1;

FIG. 4e shows the fifth step of a third method for producing the light arrangement shown in FIG. 1;

FIG. 5a shows a light arrangement according to prior art wherein two conductors are held together by LEDs;

FIG. 5b shows an LED of FIG. 5a;

FIG. 6a shows the construction of a COB LED light arrangement on a conventional printed board in a lateral view; and

FIG. 6b shows the construction of a COB LED light arrangement on a conventional printed board in a top view.

### DESCRIPTION OF THE PREFERRED EMBODIMENTS

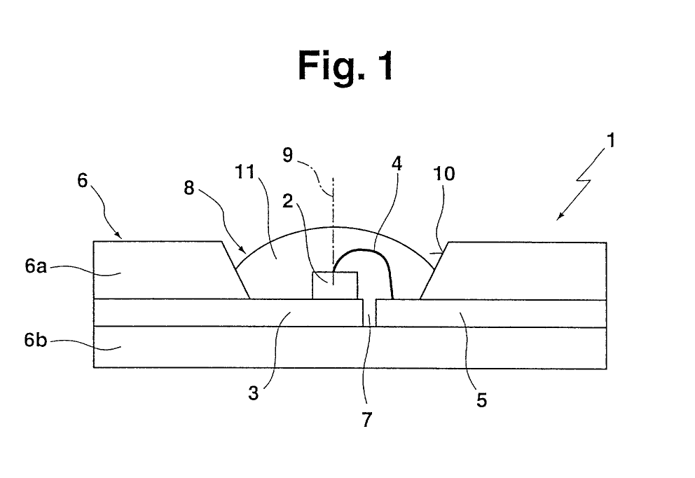

FIG. 1 shows a light arrangement 1 comprising one LED, in the embodiment shown an LED chip 2 having two chip contacts.

The LED chip 2 is mounted on a first contact plate 3 wherein the chip contact located on the lower side of the LED chip 2 is connected to the contact plate 3 in an electrically conducting fashion. The other chip contact located on the upper side of the LED chip 2 is connected to a second contact plate 5 in an electrically conducting fashion via a (bonding) wire 4. The two contact plates 3, 5 which may be punched out of a copper sheet are held at a separation (gap 7) from one another via a carrier 6. The gap 7 should be as small as possible e.g. approximately 0.5 mm. The carrier 6 consists of electrically insulating material (e.g. plastic) and covers the two contact plates 3, 5 with an upper and a lower carrier layer 6a or 6b, wherein the upper side of the contact plates 3, 5 is carrier-free around the seat region 8 about the LED 2. The end faces of the carrier 6 bordering this carrier-free seat region 8 extend at an inclined angle to the optical axis 9 of the LED and thereby form reflector sections 10 which reflect light beams, laterally radiated by the LED, towards the front. To protect the LED chip 2 from damage, the carrier-free seat region 8 is covered with a protective layer 11 which is transparent for the light of the LED. The LED chip 2 and its contacts can correspond e.g. to the COB-LED chip 61 of FIG. 6.

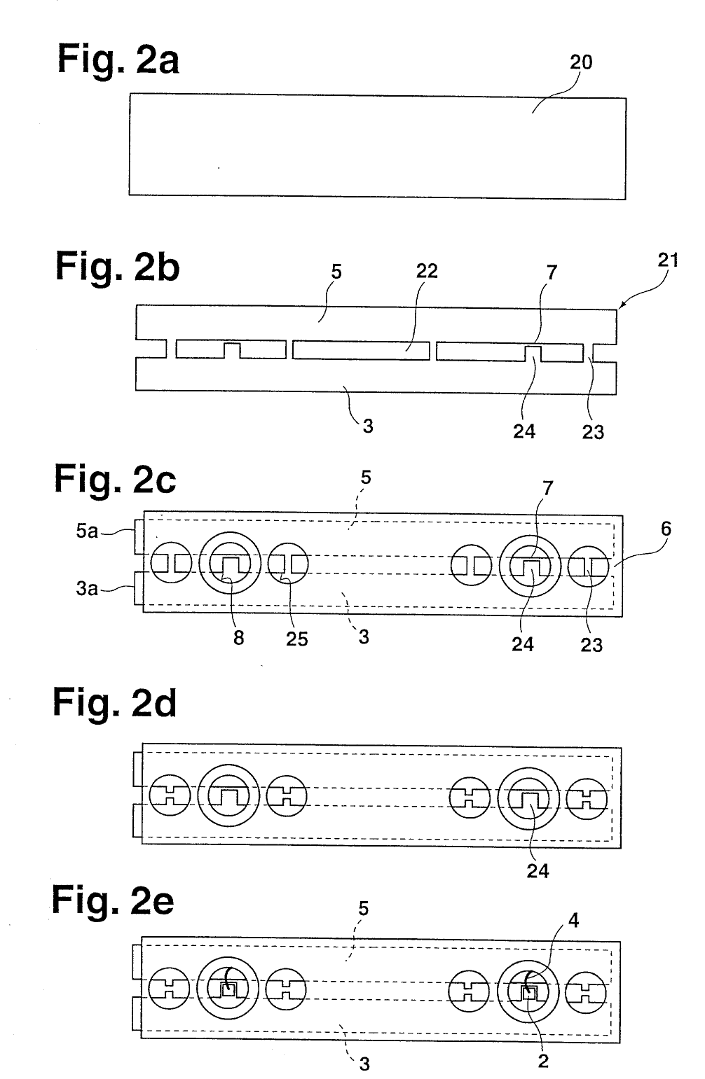

FIGS. 2a through 2e show the individual method steps for producing the light arrangement 1 shown in FIG. 1. A grid 21 comprising two contact plates 3, 5 (FIG. 2b) is punched, cut or etched out of a sheet metal 20 (FIG. 2a) of electrically conducting material (e.g. copper). The contact plates 3, 5 are spaced apart from one another by a broad dividing gap 22 and are initially connected via several bridge-like connections 23. The contact plate 3 has two projections 24 projecting into the separating gap 22, thereby narrowing the separating gap 22 in this region to the width of the smaller gap 7, e.g. to approximately 0.5 mm. In contrast to the broad separating gap 22 which may be produced with large tolerances, the smaller gap 7 has only little tolerance and may either be punched or produced by means of a laser. The grid 21 is coated with the carrier 6 of plastic material by inserting the complete grid 21 into an injection molding tool and injection-coating with plastic (FIG. 2c). On the upper side of the contact plates 3, 5 circular seat regions 8 around the projections 24 and circular regions 25 around the connections 23 are left without plastic or carrier by covering these regions 8, 25 during injection molding e.g. by a stamp. The projections 24 are each disposed in the centre of the carrier-free seat regions 8. To permit electric contact of the contact plates 3, 5, the contact ends 3a, 5a of the contact plates 3, 5 also remain carrier-free. The connections 23 are then either separated while still in the injection molding tool or subsequently in a further work step such that the two contact plates 3, 5 are completely separated from one another (FIG. 2d). Two LED chips 2 each are mounted in an electrically conducting fashion in the carrier-free seat regions 8 with their lower chip contact on the projections 24 of the first contact plate 3 and are connected (bonded) in an electrically conducting fashion with their upper chip contact via the wire 4 with the second contact plate 5 (FIG. 2e). Subsequently each LED chip 2 is coated with the transparent protective layer.

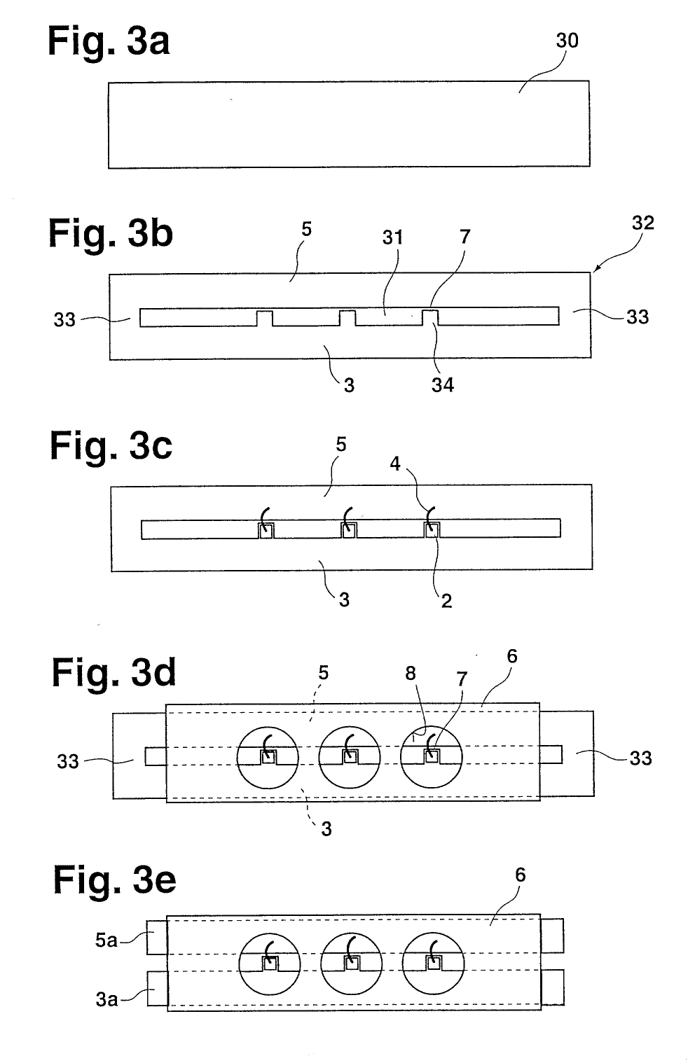

FIGS. 3a through 3e show another variant for producing the light arrangement 1 shown in FIG. 1. A grid 32 with the two contact plates 3, 5 (FIG. 3b) is produced by punching, cutting or etching out of the separating gap 31 from a sheet metal 30 (FIG. 3a) of electrically conducting material (e.g. copper) which contact plates are initially still connected at the end via a connection 33. Projections 34 of the contact plate 3 project into the separating gap 31 thereby narrowing the separating gap 31 in these regions in each case to the width of the narrower gap 7 e.g. to approximately 0.5 mm. The lower chip contact of one LED chip 2 each is disposed in an electrically conducting fashion onto each projection 34 and is connected in an electrically conducting fashion (bonded) with its upper chip contact to the second contact plate 5 via the wire 4 (FIG. 3c). The grid 32 is then inserted into an injection molding tool and injection-coated with the carrier 6 (FIG. 3d), wherein the contact plates 3, 5 in the region of the connections 33 and in the circular seat regions 8 about the LED chips 2 remain carrier-free in each case. The connections 33 are then either separated still in the injection tool or later in a further step (FIG. 3e). The contact ends 3a, 5a of the contact plates 3, 5 are formed by their ends projecting over the carrier 6. Subsequently, each LED chip 2 is covered with the transparent protective layer.

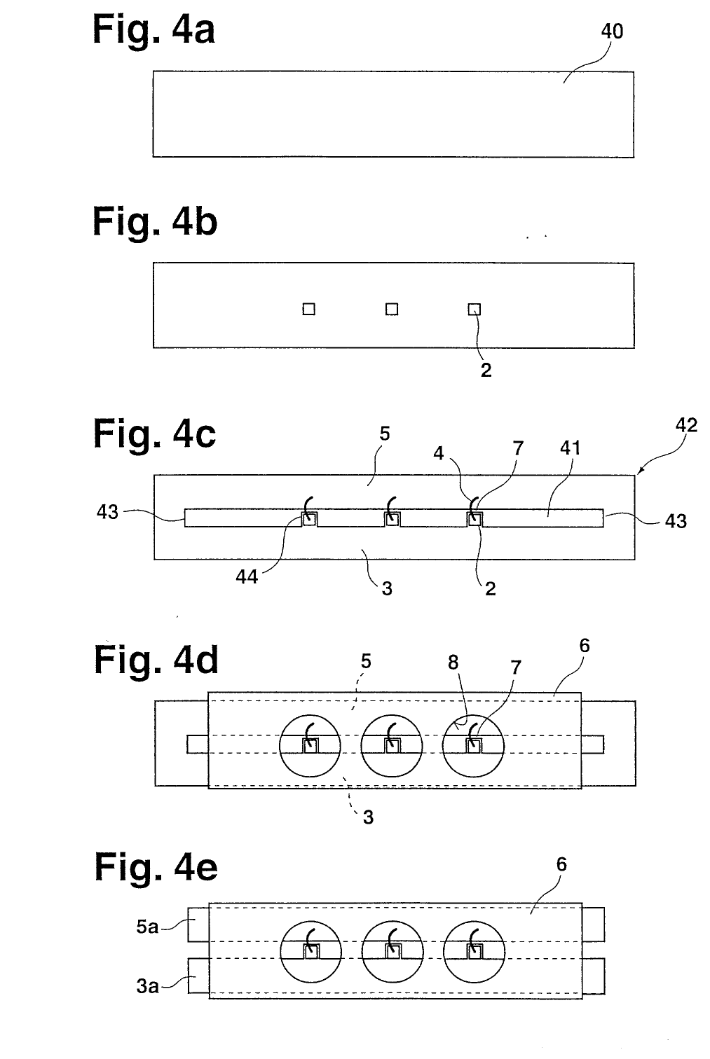

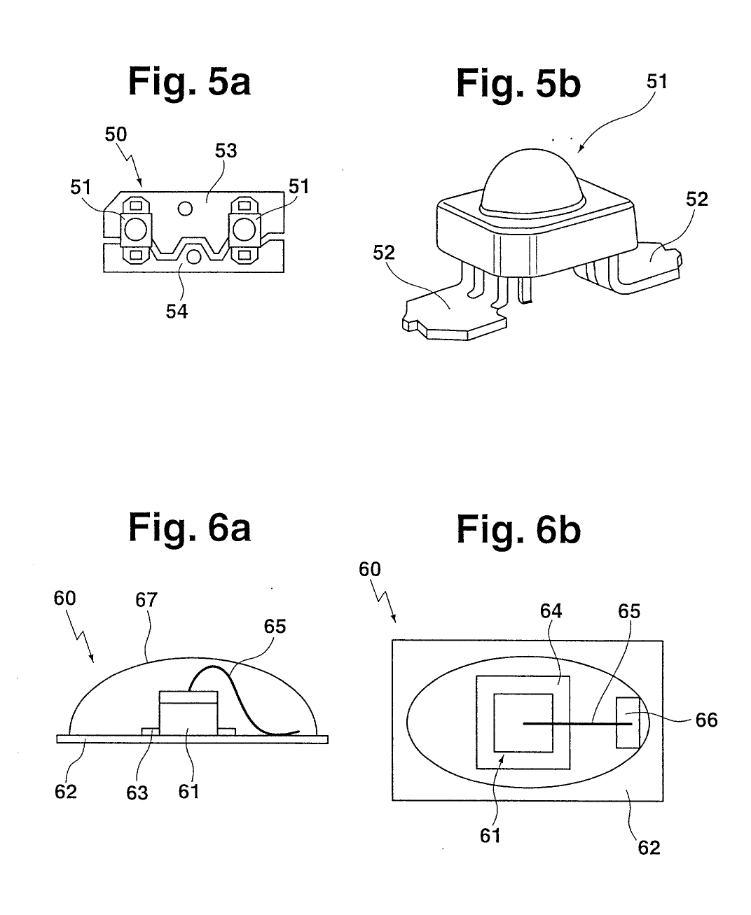

FIGS. 4a through 4e show a further variant for producing the light arrangement 1 shown in FIG. 1. Several LED chips 2 are mounted in an electrically conducting fashion, with their lower chip contacts onto a sheet metal 40 (FIG. 4a) of electrically conducting material (e.g. copper) (FIG. 4b). A grid 42, comprising the two contact plates 3, 5, is produced by punching, cutting or etching out the separating gap 41 close to the LED chips 2, the contact plates being initially interconnected at their ends via a connection 43. Projections 44 of the contact plate 3 project into the separating gap 41 on which the LED chips 2 are mounted. The separating gap 41 is narrowed in these regions to the width of the smaller gap 7, e.g. to approximately 0.5 mm, by the projections 44. The upper chip contacts of the LED chips 2 are connected (bonded) to the other contact plate 5 in an electrically conducting fashion (FIG. 4c) via a wire 4. The grid 42 is then inserted into an injection tool and injection-coated with the carrier 6 (FIG. 4d) wherein the contact plates 3, 5 in the region of the connections 43 and in the circular seat regions 8 about the LED chips 2 remain carrier-free. The connections 43 are then separated still in the injection tool or subsequently in a further step (FIG. 4e). The contact ends 3a, 5a of the contact plates 3, 5 are formed by their ends projecting over the carrier 6. Subsequently, each LED chip 2 is coated with the transparent protective layer.

We claim:

1. A light arrangement comprising two contact plates facing one another with their respective leading edge and which are spaced apart by an electrically insulating carrier, and at least one LED-chip; said contact plates each having an upper side and a lower side; said at least one LED-chip being mounted to one of said contact plates in an electrically conducting fashion and being electrically connected to the other of said contact plates by a wire; wherein said at least one LED-Chip is fixed to the upper side of said one contact plate.

2. The light arrangement according to claim 1 wherein said at least one LED-chip includes a plurality of LED-chips, the LED-Chips being arranged in a longitudinal direction of the contact plate.

3. The light arrangement according to claim 1, wherein the electrically insulating carrier is provided on at least one of the upper and lower sides of the contact plates.

4. The light arrangement according to claim 1, wherein the electrically insulating carrier is produced through injection-coating of the contact plates with plastic.

5. The light arrangement according to claim 1, wherein the carrier defines a housing part for the light arrangement.

6. The light arrangement according to claim 1 wherein the carrier defines a housing for connecting contacts of the contact plates.

7. The light arrangement according to claim 1, wherein the contact plates each have carrier-free seat regions for the LED-Chips.

8. The light arrangement according to claim 7, wherein the carrier defines a reflective surface about each carrier-free seat region to reflect light from the LED-chip.

9. The light arrangement according to claim 7, wherein the LED-Chips are each covered in the carrier-free seat regions by a separate protective layer.

10. The light arrangement according to claim 1, wherein said one contact plate includes at least one projection extending from the leading edge of the contact plate toward the other contact plate; said at least one LED-Chip being fixed to the projection.

11. The light arrangement according to claim 1, the electrically insulating carrier is provided on at least one of the upper and lower sides of the contact plates; the carrier being produced through injection-coating of the contact plates with plastic; the carrier forming a housing for at least one of the light arrangement and the connecting contacts of the contact plates; the contact plates each have carrier-free seat regions for the LED-Chip, the carrier defining a reflective surface about each carrier-free seat region; the LED-Chips each being covered in the carrier-free seat regions by a separate protective layer; said one contact plate including at least one projection extending from the leading edge of the contact plate toward the other contact plate; said at least one LED-Chip being fixed to the projection.
